(19) United States
(12) Patent Application Publication
(10) Pub. No.: US 2022/0397369 A1
(43) Pub. Date: Dec. 15, 2022

(54) Crossbow Device and Method for Shooting an Arrow with Such a Device

(71) Applicant: Country Innovation and Supply, LLC, Winder, GA (US)

(72) Inventor: Keaton Smith, Winder, GA (US)

(73) Assignee: Country Innovation and Supply, LLC, Winder, GA (US)

(21) Appl. No.: 17/828,888

(22) Filed: May 31, 2022

Related U.S. Application Data
(60) Provisional application No. 63/208,738, filed on Jun. 9, 2021.

(51) Int. Cl. F41B 5/12; F41B 5/14; C09J 7/38

(52) U.S. Cl. CPC F41B 5/123; F41B 5/143; C09J 7/38; C09J 2301/302

(57) ABSTRACT

An improved crossbow and improved bow and methods for shooting an arrow from such crossbow and how devices. The improved how comprises a pressure sensitive adhesive (PSA) tape on the rail or arrow rest, the surface the arrow slides over when released. The PSA tape provides a smooth surface for the arrow to glide over thereby reducing friction. This is an improved over prior art products such as rail lube or silicone products. The disclosure also comprises an improved method for shooting an arrow with a crossbow comprising PSA tape on the rail or arrow rest.

The following application is a non-provisional application for patent under 35 USC 111 (a). The present application claims priority to U.S. Provisional application No. 63/208,738 filed Jun. 9, 2021 by the same inventor and applicant.

### FIELD OF DISCLOSURE

This disclosure relates to the field of outdoor activities in particular bows and crossbows and a method of shooting an arrow with a bow or crossbow.

### BACKGROUND

Several products are used with bows and crossbows to increase longevity of the device and improve speed and accuracy of the released arrow. In crossbows, a rail lube or silicone, being a lubricating composition designed to increase slide or slip of the serving, the portion of the string or cables that receives the arrow and contacts the rail, is used to reduce friction between the rail and the serving. In more traditional bows, the arrow sits on an arrow rest and the shaft glides over the arrow rest when the arrow is released. The arrow rest may be made of wood, metal, plastic, or other composite material. These arrow rests tend to be coated with either serving string or felt to reduce friction of the arrow on the rest when it is released, thereby improving speed and accuracy.

The problem with rail lube or silicone is that in cold temperatures the composition gets cold and sticky, losing its friction reducing ability. Additionally, the rail lube or silicone gets dirt and other particulate matter stuck to it. Further, rail lube need be applied with each use of the bow. Serving string and felt products adhered to an arrow rest do little to reduce the friction on either the arrow or the arrow rest. What is needed in the art is a product that improves glide of the arrow and serving over the rail or rest, respectively, to improve speed of the arrow and prolong life of the bow and arrows.

### BRIEF DESCRIPTION OF THE DISCLOSURE

The disclosure comprises, an improved crossbow, the crossbow comprising a rail lined, on the side that contacts the arrow, with a pressure sensitive tape, the tape having at least 5 mils in thickness, 5 oz/in peel adhesion, at least 5 lbs/in tensile strength, at least 100% elongation at break, and an operating temperature range of at least −20° F. to +350° F. The improved crossbow may be comprised of a the pressure sensitive tape with at least 7 mils in thickness, 10 oz/in peel adhesion, at least 10 lbs/in tensile strength, at least 150% elongation at break, and an operating temperature range of at least −10° F. to +200° F. In as much, the improved crossbow may have a pressure sensitive tape with at least 9 mils in thickness, 15 oz/in peel adhesion, at least 15 lbs/in tensile strength, at least 200% elongation at break, and an operating temperature range of at least 0° F. to +150° F. Further, the improved crossbow may have a pressure sensitive tape with at least 9.5 mils in thickness, 20 oz/in peel adhesion, at least 20 lbs/in tensile strength, at least 200% elongation at break, and an operating temperature range of at least 10° F. to +125° F. The improved crossbow may have a pressure sensitive tape with at least 9.8 mils in thickness, 25 oz/in peel adhesion, at least 25 lbs/in tensile strength, at least 225% elongation at break, and an operating temperature range of at least 10° F. to +125° F. The improved crossbow may have a pressure sensitive tape comprised of RULON®.

Further, the disclosure comprises an improved bow, the bow comprising on a surface that contacts the arrow as it is released, a pressure sensitive tape, the tape having at least 5 mils in thickness, 5 oz/in peel adhesion, at least 5 lbs/in tensile strength, at least 100% elongation at break, and an operating temperature range of at least −20° F. to +350° F. The improved bow may comprise pressure sensitive tape with at least 7 mils in thickness, 10 oz/in peel adhesion, at least 10 lbs/in tensile strength, at least 150% elongation at break, and an operating temperature range of at least −10° F. to +200° F. The improved bow may comprise a pressure sensitive tape with at least 9 mils in thickness, 15 oz/in peel adhesion, at least 15 lbs/in tensile strength, at least 200% elongation at break, and an operating temperature range of at least 0° F. to +150° F. Further, the improved bow may comprise a pressure sensitive tape with at least 9.5 mils in thickness, 20 oz/in peel adhesion, at least 20 lbs/in tensile strength, at least 200% elongation at break, and an operating temperature range of at least 10° F. to +125° F. More so, the improved bow may comprise a pressure sensitive tape with at least 9.8 mils in thickness, 25 oz/in peel adhesion, at least 2.5 lbs/in tensile strength, at least 225% elongation at break, and an operating temperature range of at least 10° F. to +125° F. Even, the improved bow may comprise a pressure sensitive tape that is comprised of RULON®.

The disclosure further includes an improved method for shooting an arrow with a bow device, the method comprising: lining a rail or arrow rest of the bow with a pressure sensitive tape, the tape being at least 5 mils in thickness, 5 oz/in peel adhesion, at least 5 lbs/in tensile strength, at least 100% elongation at break, and an operating temperature range of at least −20° F. to +350° F.; fitting the arrow onto the serving; drawing the arrow back; and releasing the arrow. The method may comprise a pressure sensitive tape with at least 7 mils in thickness, 10 oz/in peel adhesion, at least 10 lbs/in tensile strength, at least 150% elongation at break, and an operating temperature range of at least −10° F. to +200° F. The method may comprise a pressure sensitive tape with at least 9 mils in thickness, 15 oz/in peel adhesion, at least 15 lbs/in tensile strength, at least 200% elongation at break, and an operating temperature range of at least 0° F. to +150° F. The method may comprise a pressure sensitive tape with at least 9.5 mils in thickness, 20 oz/in peel adhesion, at least 20 lbs/in tensile strength, at least 200% elongation at break, and an operating temperature range of at least 10° F. to +125° F. The method may comprise a pressure sensitive tape with at least 9.8 mils in thickness, 25 oz/in peel adhesion, at least 25 lbs/in tensile strength, at least 225% elongation at break, and an operating temperature range of at least 10° F. to +125° F. Further, the method may comprise a pressure sensitive tape that is RULON®.

### BRIEF DESCRIPTION OF THE DRAWINGS

FIG. 1 is a prior art diagram illustrating parts of a compound crossbow.

FIG. 2 is a prior art diagram illustrating parts of a recurve crossbow.

FIG. 3 is a prior art picture of a repeating crossbow.

FIG. 4 is a prior art picture of a rile crossbow.

FIG. 5 is a prior art diagram illustrating parts of an arrow.

FIG. 6 is a picture of an improved crossbow of the present disclosure.

FIG. 7 is a picture of an improved crossbow of the present disclosure.

FIG. 8 is a picture of an improved crossbow of the present disclosure.

FIGS. 9, 10, 11, 12 and 13 are prior art bow arrow rests.

FIG. 14 are prior art arrow rest linings.

FIG. 15 is a PSA arrow rest liner of the present disclosure.

Before explaining the disclosed embodiments of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE INVENTION

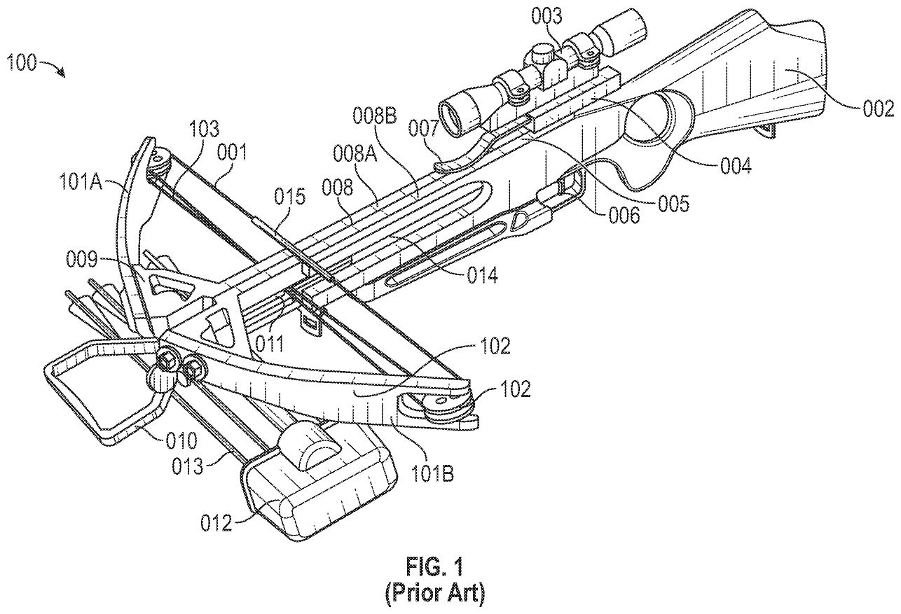

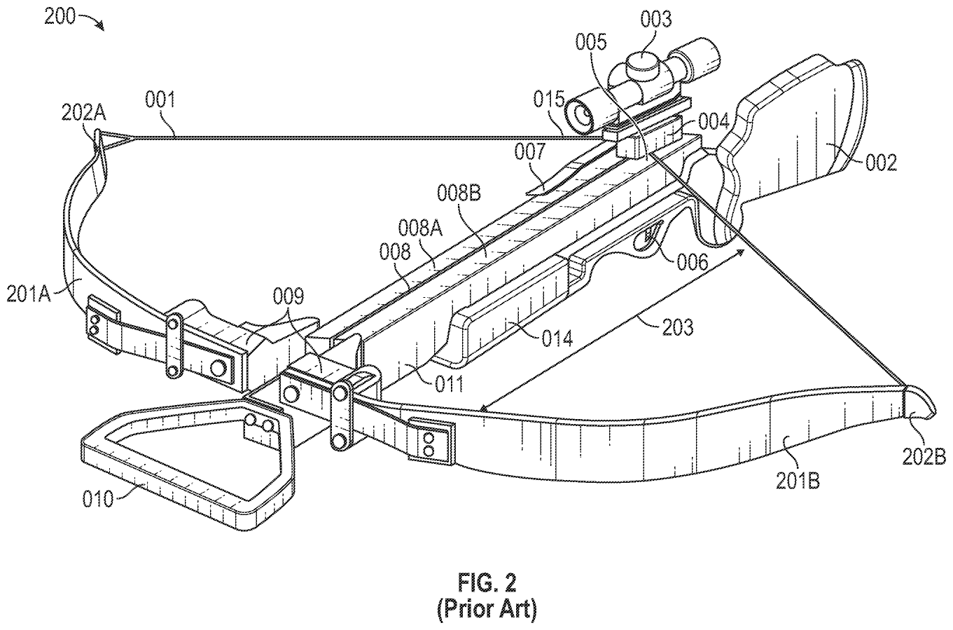

Crossbows come in a variety of types. The compound crossbow 100, an example of which is shown in prior art FIG. 1, features a more complex design than a recurve crossbow 200, FIG. 2 and is therefore harder to set up the first time. But it is much easier to use and therefore a highly popular choice for hunters. Its design is marked by much shorter limbs 101A, 101B as compared to the recurve of FIG. 2, 201A, 201B yet they are very sturdy. The compound crossbows 100 as in FIG. 1, are renowned for high energy-efficiency thanks to their stiff build. Compound crossbows 100 also utilize synthetic material of manufacture to enhance durability. As a result of the design, this compound crossbow 100 is renowned for accuracy and is resistant to weather changes.

The compound crossbow 100, illustrated in prior art FIG. 1, features a string 001 connected to a pulley system being a cam or wheel 102, and connecting a first limb 101A and second limb 101B via this same system. The first and second limbs 101A, 101B may alternately be made of one piece of wood or two pieces or made from other material being magnesium or aluminum alloy or carbon fiber as mentioned above. When the string 001 is drawn back, the cams 102 turn and the cables 103 move to bend the limbs 101A, 101B, saving up lots of energy for the shot and this energy makes it a very fast shooter. Another advantage characterizing this compound crossbow 100 is the fact that they are easier to use thanks to their short draw length. They are also very compact, being narrower than recurves, and thus can be used comfortably in limited space. The design minimizes vibration and recoil and thus makes the bow very accurate and not as noisy making it ideal for pro hunters.

However, these compound crossbows 100 as shown in prior art FIG. 1 are much heavier than the recurve crossbows 200, FIG. 2. When the string 001 of a compound crossbow breaks, a special tool is required for restringing. They don't handle impact very well and lose accuracy rather easily when fired repeatedly. The numerous parts of these bows mean that its maintenance is rather complicated, and wear and tear also happens quite fast.

The recurve crossbow 200, an example of which is shown in prior art FIG. 2, may be the oldest ancestor of the modern crossbow. Its name is inspired by the delicate curves 202A, 202B that mark the ends of the bow pointing away from its user. These curves 202A, 202B carry out the important function of keeping the string 001 in place so that it does not flick out. They do this by straining the string 001 and locking it in and thus ensure the safety of the user as well as the equipment. Traditionally this bow was made of wood.

The modern-day recurve crossbow 200 of prior art FIG. 2 is either made from magnesium alloy, aluminum alloy, or carbon fiber and is still very easy to aim. They usually feature a longer draw length 203, or length that a bow can be drawn or pulled, than all the other bows, a feature that enables them to offer greater acceleration for the projectile. They are also noisy when fired due to the great pressure exerted on the bow as a result of their length. It is suited for hunting expeditions that require remarkable power and speed, for instance when targeting large game. It is also ideal for taking long range shots and is a favorite for pro hunters.

The biggest disadvantage the recurve crossbow 200, FIG. 2 has is that the design causes a significant strain on the string 001 and could therefore mean the need to keep buying new strings unless you invest in a very high quality one. Additionally, recurve crossbows 200 are quite big and therefore inconvenient to carry around in the wilderness.

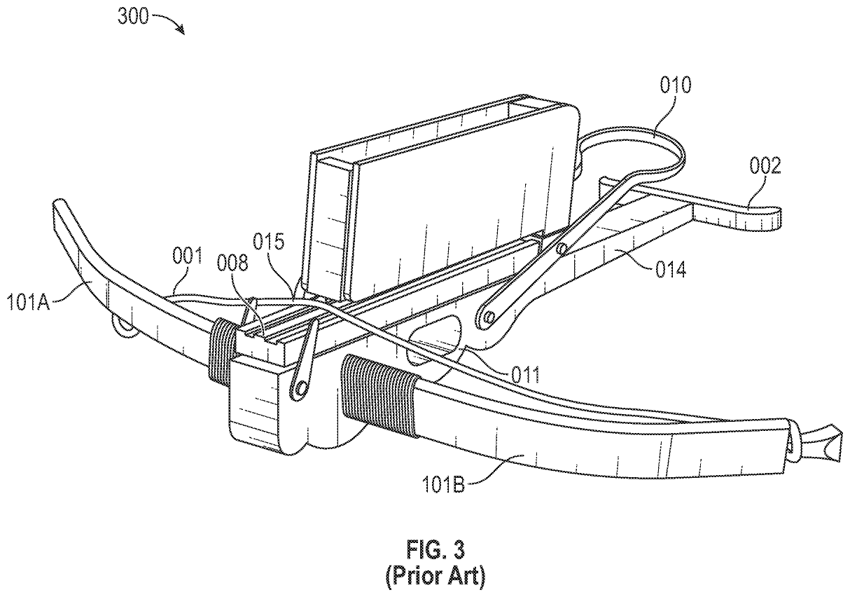

The repeating crossbow 300, shown in prior art FIG. 3, is one of the simplest to use as it takes a single movement to execute a shot. As with the bows described above a string 001 and limbs 101A, 101B form the main part of the bow 300. All the other steps are initiated a single motion making it one of the most convenient crossbow options available. It is said to be capable of shooting three times faster than an ordinary crossbow and is therefore the best choice when speed is of the essence. It makes it possible to repeat shots as many times unlike the others whose single shot is a do-or-die. It therefore provides a convenient shortcut for beginners who do not wish to put in all the work required to become a skilled archer. However, since the technology behind it is mostly mechanical, it takes all the fun out of hunting since almost everything is beyond the user's control. There is no way of enhancing its performance and it takes no technique to master its use.

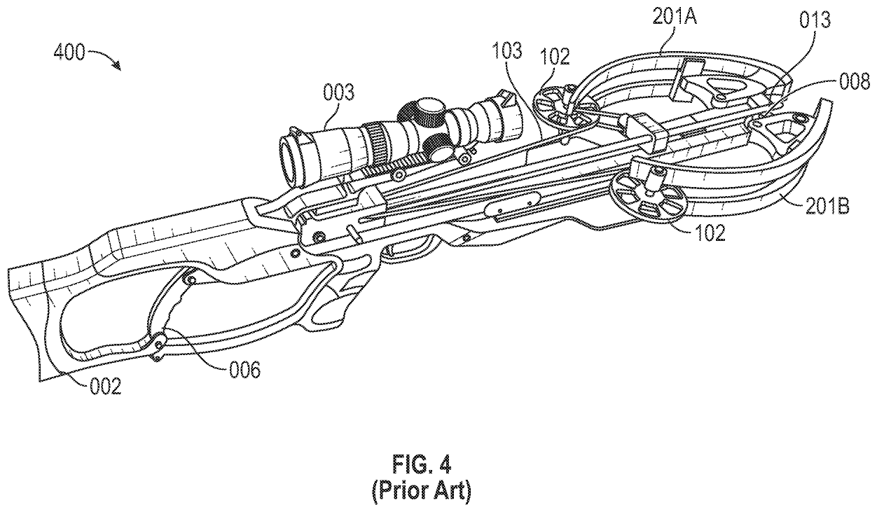

The rifle crossbow 400 is a modern-day hybrid combining the highlights of ordinary crossbows and the conveniences of the rifle to make the ultimate hunting instrument, an example as shown in prior art FIG. 4. Just like the rifle, this rifle crossbow's 400 greatest strength is accuracy, a quality enhanced by its superior aim capability. These rifle crossbows 400 incorporate technological advancements like impressive sights 003, a heavy-duty construction based on fiber and a foot-pull. They are designed for long range hunts and could ensure accurate shots from as far off as 250 feet.

The rifle crossbows 400, like those shown in prior art FIG. 4, are a lot narrower than the other crossbows in the market and could measure a mere six inches in width. This means they can penetrate even the narrowest of spaces in densely forested areas giving you a great perspective on your unsuspecting prey. The rail design is top-notch which makes it possible for the rifle crossbow 400 to launch bolts or arrows with zero friction resulting in unmatched velocity. The downside to this impressive weapon is that it requires quite a significant amount of power to operate it and launch a bullseye shot. This is because it packs up a lot more power than most and involves a relatively complex cocking process.

As illustrated in prior art FIGS. 1-4, the parts of a crossbow, in general, may include most of the following components: 1) a string, or strings 001, 2) a stock 002 which may also be known as the handle end of the gun; 3) a sight 003, which may be a scope, much like a telescope, for viewing things at a distance; 4) sight bridge 004 for mounting the sight; 5) latch 005; 6) trigger 006; 7) arrow retention spring 007; 8) flight groove or arrow track 008, the sides formed by rails 008A, 008B of the barrel, also known as the power stroke; 9) one or more limbs 101A,B 201A,B, which may be single or split; 10) cables 103 which may have a cam/wheel 102 in compound models around which they are threaded; 11) riser 009; 12) cocking stirrup 010; 13) barrel 011. A quiver 012 may hold additional arrows 013. A foregrip supplies a gripping portion 014. The portion of the string that contacts the flight groove 008 is called the serving 015.

Referring to prior art FIGS. 1 and 2, the arrow retention spring 007 (or arrow retention brush) holds the arrow in the track until the trigger releases the latch mechanism. The barrel 011 may be made of aluminum, polymer, wood, composite, or any applicable material. The cocking stirrup 010 is used to aid in cocking the crossbow. The archer's foot is placed in the stirrup to prevent the bow from slipping when it is cocked. The flight groove 008 is a grooved track on top of the barrel or rails 008A, 008B that allows the arrow to lie in perfect alignment with the string for consistent accuracy. The latch 005 is designed to capture the string when the crossbow is cocked or drawn. The latch 005 holds the string in place until it's released by the trigger. The limbs 101A,B 201A,B can be compound or recurve. A recurve crossbow 200, FIG. 2 must have long limbs and a longer barrel to deliver power similar to that of a compound crossbow 100, FIG. 1.

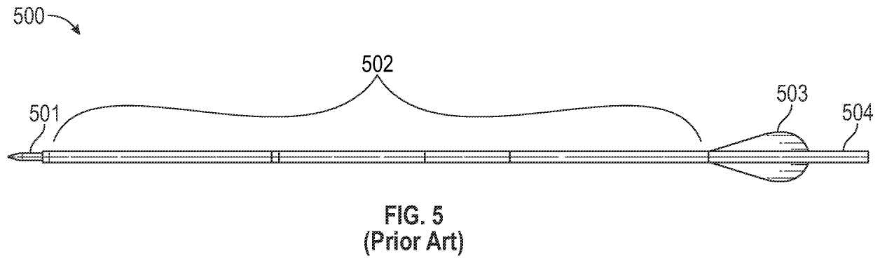

Referring to prior art FIGS. 1 and 2, the riser 009 is where the limbs 101A, B 201A, B attach. The safety 016 prevents the arrow from releasing accidentally. The safety 016 may engage automatically or manually when the crossbow is cocked. The sight bridge 004 holds the sight 003. The stock 002 may be made of wood or composite materials and available in many configurations. As shown in prior art FIG. 5, an arrow 500, in general, comprises a tip or arrow tip 501, shaft 502, fletching 503, and nock 504.

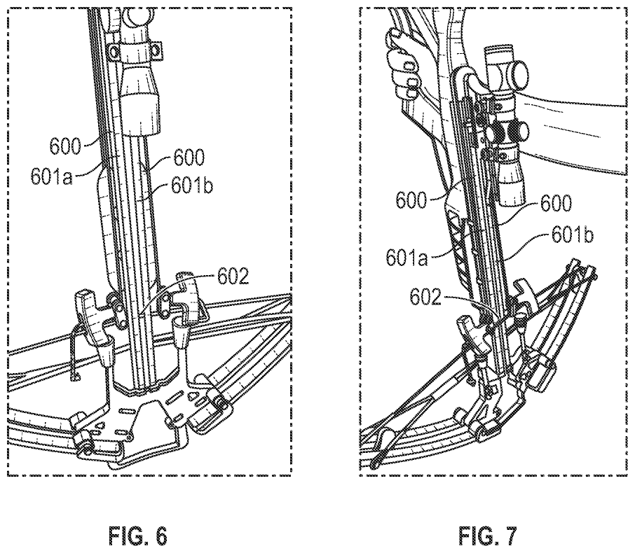

As shown in FIGS. 6 and 7, being different views of the same device, a compound crossbow 100 similar to that shown in FIG. 1, the present disclosure comprises an improved crossbow wherein the power stroke or rail 600 as it will be referred to in the present disclosure hereafter, may be lined with a RULON® (Saint-Gobain, saint-gobain.com) or similar pressure-sensitive adhesive (PSA) tape 601a, 601b, as described below, which helps the serving 602 slide over the rail 600 at a faster speed by reducing tension between the serving 602 and the rail 600.

The present disclosure includes an improved method for shooting an arrow with a crossbow. The method comprises placing, via pressure sensitive means of pressing or rubbing, or the like, the RULON® or similar, as described below, pressure-sensitive (PSA) tape 601a, 601b on the rail(s) 600 of the crossbow FIG. 6 placing the nock of the arrow on the serving 602 of the string 001 and cocking the string. The arrow may be placed in the arrow retention spring and rested on the arrow groove. When the crossbow is fired, the string is released, and it launches the arrow toward its intended target. This tape 601a, 601b eliminates the need for prior art rail lube or silicone that is typically placed on the rail 600 to reduce friction from the serving rubbing on the rail causing wear on the serving. Prior art rail lube or silicone products have the problem of becoming sticky under certain conditions such as cold temperatures. In addition, dirt and debris stick to the rail lube or silicone reducing efficiency of the crossbow and causing further wear on the rail. Use of the RULON® or similar pressure-sensitive adhesive (PSA) tape 601a, 601b on the rails improves the crossbow function and protects the rail 600 and serving.

FIG. 7 shows another view of a portion of the crossbow being the rails 600 fitted with the RULON® or similar pressure-sensitive (PSA) tape 601a, 601b. A RULON® pressure-sensitive (PSA) tape may have a backing of similar to a Film-Rulon®, such as that available from Saint-Gobain (saint-gobain.com), being manufacture from skived, patented, filled PTFE film and coated on one side with high-temperature pressure-sensitive adhesive. The skived, patented, filled PTFE film may include a pigment to give color to the film. The pressure-sensitive adhesive may be an acrylic adhesive. The special feature of pressure sensitive adhesives is that they do not solidify to form a solid material but remain viscous. As a result, they remain permanently tacky and have the ability to wet surfaces on contact. Bonds are made by bringing the adhesive film in contact with the substrate and applying pressure. If inadequate pressure is applied or the processing temperature is too low, bonding faults such as bubbles or detachment can occur. Since these adhesives are not true solids, the strength of pressure sensitive adhesives decreases when the temperature is increased. Pressure sensitive adhesives also exhibit a tendency to undergo creep when subjected to loads. They are typically formulated from natural rubber, certain synthetic rubbers, and polyacrylates.

The width of the pressure-sensitive (PSA) tape FIG. 8 601a, 601b on the rails may be at least a one-eighth of the width of the rail, or at least one-quarter of the width of the rail, or at least one-half the width of the rail, or at least two-thirds the width of the rail, or at least three-fourths the width of the rail, or more. The tape may be applied the full length of the rails, or at least most of the length of the rails, or at least the length of the rails wherein the server makes contact, or more.

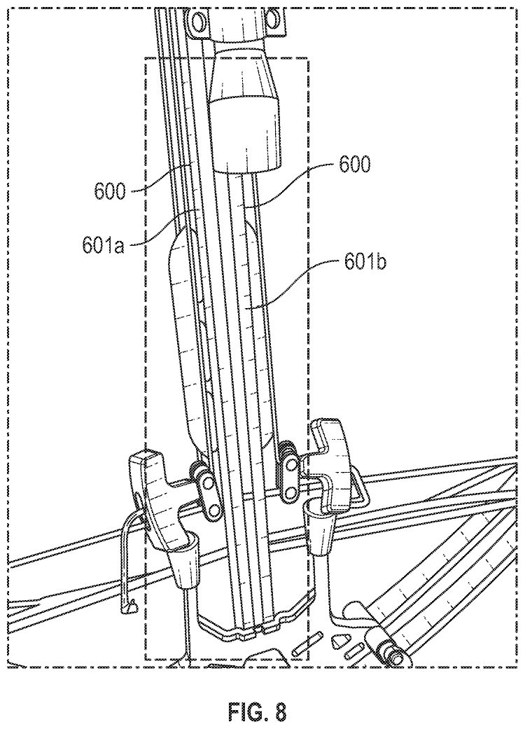

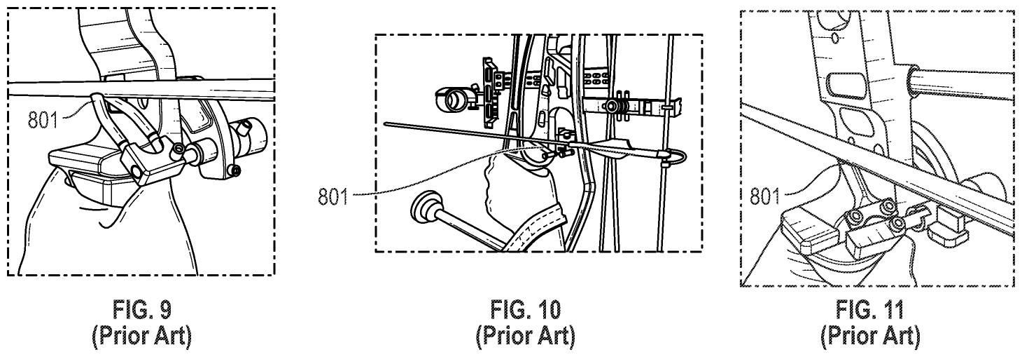

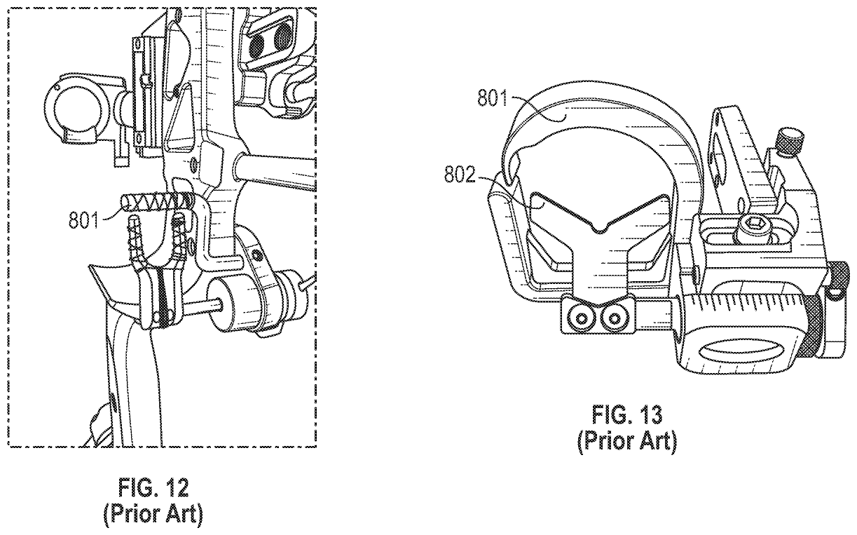

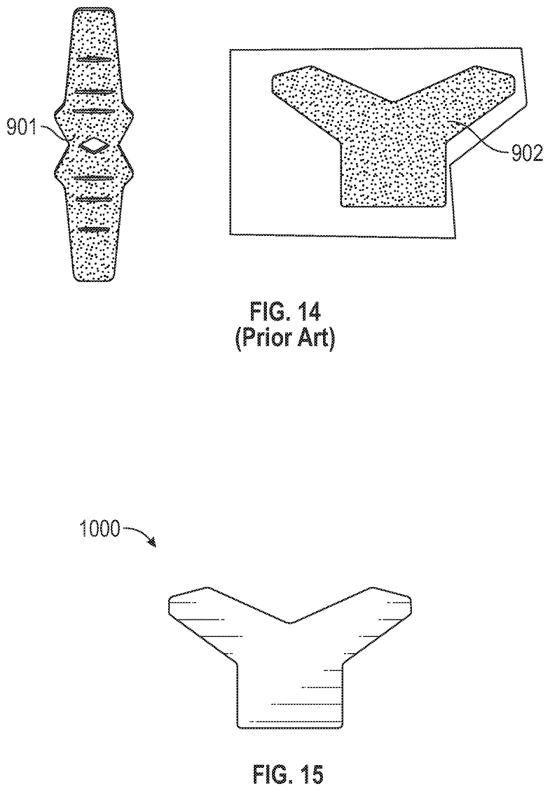

A pressure-sensitive (PSA) tape product may be placed on other parts of a bow, for instance on a more traditional bow with an arrow rest 801, FIGS. 9-13. Examples of these prior art bow arrow rests 801 can be seen in FIGS. 9-13. As seen in prior art FIG. 12, serving string 015 has been wrapped around the arrow rest 801 to improve slide and reduce friction. In prior art FIG. 13, the arrow rest 801, 802 does not contain a slide or friction aid. FIG. 14 illustrates two prior art objects made of felt or other fabric material 901 with an adhesive back designed to fit onto the arrow rest of FIG. 13 801, 802. The felt or fabric material 901 of FIG. 14 being designed to fit on top and on the underside of the top of the rest, FIG. 13 801. The object 902, being felt or fabric material of FIG. 15 being designed to fit onto the arrow rest of FIG. 13 802.

The present disclosure includes a pressure-sensitive (PSA) tape product, as described further below, that is cut to a shape to fit any bow arrow rest 801,802 FIGS. 9-13. For example, FIG. 15 illustrates a pressure-sensitive (PSA) tape product 1000 cut to nearly match 902 of FIG. 13 that can be applied to the surface of 802 of FIG. 13. In this way the pressure-sensitive (PSA) tape product 1000, FIG. 15 of the present disclosure, placed on a bow arrow rest or other bow structures, creates an improved bow. The method for shooting an arrow across a rest fitted with pressure-sensitive (PSA) tape product or similar tape product 1000, FIG. 15 as described herein creates an improved method for shooting an arrow. The method comprises the pressure-sensitive (PSA) tape product as described herein being shaped or cut, which may be via die cut or other cutting method, to specific shape and size to fit the given arrow rest, fitted to an arrow rest via pressure sensitive means, whether via pressing, rubbing, or the like, fitting an arrow on the server, drawing back the arrow, and releasing the arrow across the surface of the pressure-sensitive (PSA) tape as described below.

A pressure-sensitive (PSA) tape product or pressure sensitive adhesive tape can be defined as a continuous flexible strip of cloth, paper, metal, or plastic coated on one or both sides with a permanently tacky adhesive at room temperature which will adhere to a variety of surfaces with light pressure (finger pressure) with no phase change (liquid to solid) and usually in roll form. PSAs, or pressure sensitive adhesives can be blends of natural or synthetic rubber and resin, acrylic, silicone or other polymer systems, with or without additives.

Pressure sensitive adhesives can be supplied dissolved in organic solvents, as an aqueous dispersion, as a hot melt, or coated on release liner as tape. Liquid applied (solvent or water based, hot melt) pressure sensitive adhesives can be applied in bead or ribbon, sprayed, or roll coated. After coating and drying of solvent or water-based systems, parts can be bonded or the adhesive covered with release liner for bonding later. The adhesive can be coated in a pattern to provide bonded and unbonded areas, e.g. assembly of membrane switches, filter frames. Pressure sensitive adhesives are often used to temporarily hold components like gaskets in position during assembly.

An adhesive may be applied to both sides of a backing. The release liners are commonly paper and coated on both sides of the paper with silicone release agents creating a differential release. The pressure sensitive adhesive is coated on both sides of the carrier which is typically a polymeric film such as 0.5 mil polyester. The adhesive on each side of the carrier may be the same or different chemistries and may have the same or different coating thicknesses. Examples of double coated tapes include mounting, medical and membrane switch.

In addition to the backing and adhesive, these tapes may include a reinforcement layer of woven or knitted cloth or glass strands parallel to the machine direction. Typical backings include polymeric films such as polyethylene and polyester. Rubber based adhesives are the most common but others can be used. Examples of reinforced tapes are duct and filament. Unsupported PSA tapes consist of release liners and adhesives. The release liners are commonly paper and coated on both sides of the paper with silicone release agents creating a differential release. Acrylic adhesives are commonly used in this application. Examples of unsupported tapes are envelope sealing and splicing.

An acrylic adhesive is a resin-based adhesive comprised of acrylic or methylacrylic polymers. They are extremely strong and efficient in bonding multiple objects together and are very environmentally resistant. Because of this environmental resistance, acrylic adhesives are often the preferred adhesive in the construction industry.

Acrylic adhesives can be among the strongest adhesives available on the market today. This is largely due to two factors: their cohesion and adhesion. Cohesion is the measure of an adhesive's ability to stick to itself, while adhesion is its ability to stick to other objects. Acrylic adhesives have among the best cohesion and adhesion in the industry—these factors are influenced by the adhesive's cure time, cure temperature, and viscosity. Acrylic adhesives are high viscosity, with longer cure times and higher cure temperatures.

Acrylic adhesives are available in either liquid or paste form. Liquid acrylic adhesives are commonly applied with a brush or damp cloth and are used for upholstery or carpentry applications. Liquid acrylic adhesives are more flexible and thinner, so projects that require a seamless appearance are best performed with a liquid adhesive.

Paste acrylic adhesives are more commonly found and can be used on virtually any surface for any application. Paste acrylic adhesives can also be used in conjunction with liquid acrylic adhesives for an even stronger bond. The paste texture is used often to “sandwich” two objects together for a completely permanent bond.

While most acrylic adhesives are praised for their permanence, a temporary acrylic adhesive is also available. These adhesives are constructed with low viscosity, cohesion, and adhesion, so they can be easily broken apart with water or adhesive removers, unlike traditional permanent acrylic adhesives.

Adhesion to steel or peel adhesion is the strength the bond between a tape and the application surface. PSTC and ASTM adhesive test methods are helpful in the evaluation and testing of adhesive tapes. The standards help to identify adhesive performance properties, including adhesion, tensile strength, shear and elongation. The standards are also instrumental in determining various applications such as in electrical, insulation, sealing. Adhesion is the strength of the bond between a tape and the application surface. To measure adhesion, tape is applied to a stainless steel panel. The tape is then removed. The force required to remove (or peel) the tape determines its adhesion level. The force is measured in ounces per one inch of tape. Peel adhesion can be tested by two methods. The 90-degree peel method or pulling the tape perpendicularly to itself is the best measurement of peel adhesion of diverse substrates. This is typically used for fastening tapes. The 180-degree peel method (PSTC 3 and PSTC 1) or pulling the tape back onto itself is often used to measure the adhesion of masking and packaging tapes. Peel adhesion is not a perfect correlation to the strength of the adhesive bond. Because the test measures the initial bond, and many tapes have adhesives that build bond strength over time. Also, the test utilizes stainless steel as the surface for which the tape is applied. Typically, tape is not applied to stainless steel in real-life applications. However, the test is a good indicator of relative adhesion strength from one tape to another.

As such the peel adhesion or adhesion to steel of the PSA of the present disclosure may be at least 5 ounces (oz)/inch (in), or at least 10 oz/in, at least 15 oz/in, or at least 20 oz/in, or at least 25 oz/in or more.

Cohesion is the internal strength of an adhesive. Cohesive failure can be observed when removing an applied tape and finding adhesive residue on both the tape backing and the applied surface. This would indicate that the adhesive has poor internal strength, or poor cohesion.

Shear is a measure of the internal or cohesive strength of the adhesive, not a measure of the bond between the adhesive and substrate. Shear is the ability of an adhesive to resist creep or slippage. This property is measured by adhering a one-inch piece of tape to a stainless steel panel, then hanging a weight on one end of the tape. Shear is expressed in units of time prior to the tape slipping from the steel panel. Good shear properties are especially important for applications like splicing where the tape is used for holding two substrates together, with force being applied in opposite directions.

Tack, often referred to as Quick Stick, is the ability of a tape to create an immediate bond, during the initial contact of the adhesive with the substrate, without applying external pressure.

Tensile strength is the force (or load) required to break a tape. This property is measured by taking a one-inch-wide piece of tape, grabbing it at both ends, and then pulling in opposite directions until the tape breaks. Tensile strength is measured in pounds per one inch of tape.

As such the PSA tape of the present disclosure may have a tensile strength of at least 5 pounds (lb)/in, or at least 10 lbs/in, or at least 15 lbs/in, or at least 20 lbs/in, or at least 25 lbs/in or more.

Elongation is the percent in which a tape can be stretched just before breaking. Some tapes have a creped, or somewhat wrinkled, backing that allows the tape to have more stretch and conformability. This property is measured using the same method for measuring tensile strength. The thickness of a tape is the distance between the two opposite surfaces of the whole tape. Thickness is expressed in mils, or thousandths of an inch.

As such the elongation at break of the PSA tape of the present disclosure ay be at least 100%, or at least 150%, or at least 200%, or at least 225% or more.

Pressure sensitive adhesive (PSA) is a form of adhesive that bonds two or more materials together as pressure is applied to them. The strength of the bond depends on the amount of pressure applied. No heat, water or solvent is required to activate the adhesive. This type of adhesive is used for labels, notepads, vehicle trim, and some adhesive tapes. PSAs are designed to maintain a bond at room temperatures.

The performance of an adhesive depends on its wettability, which means its ability to make full contact and coverage of the substrates it is bonding. PSAs can be sensitive to lower temperatures. They will decrease the adhesive's flexibility and reduce their wettability. When the temperature becomes very low, some adhesives may become brittle and will not produce any stickiness.

Many applications such as this one require adhesives that can maintain, i.e. hold sticking ability, at low temperatures. This can be described as operating temperature or a temperature at which the tape is operable and maintains adhesive ability. Some polymers enable the adhesives to maintain tack and elasticity well at low temperatures. As such the PSA tape of the present disclosure may have an operating temperature of at least −20° F. to +350° F. (−29° C. to +177° C.), or at least −15° F. to +350° F., or at least −10° F. to +350° F., at least −5° F. to +350° F., or at least 0° F. to +350° F., or at least 5° F. to +350° F., or at least 10° F. to +350° F. or at least 15° F. to +350° F., or at least 20° F. to +350° F., or at least 25° F. to +350° F., or more. The PSA tape of the present disclosure may have an operating temperature of at least −20° F. to +300° F., or at least −20° F. to +250° F., or at least −20° F. to +200° F., or at least −20° F. to +150° F., or at least −20° F. to +100° F., or less.

The PSA tape may be at least a thickness of 5 mils, or 7 mils, or 9.5 mils, or at least 9.8 mils, or at least 10 mils, or at least 10.3 mils, or at least 10.5 mils, or more.

As such an improved method for shooting an arrow with an improved crossbow device may include lining a rail of the crossbow with a PSA tape as disclosed and described herein. The method may further include cocking the arrow and releasing the arrow to therefore shoot or launch the arrow from the crossbow device. The method may further include aiming the arrow with or without the use of the sight. Because various crossbows employ various parts and method and parts may differ between crossbows, one can envision various method for releasing the arrow from a PSA tape lined rail.

As such an improved method for shooting an arrow with an improved bow device may include lining the arrow rest of a bow with a PSA tape as disclosed and described above. The method may further include cocking the arrow and releasing the arrow to therefore shoot or launch the arrow over the arrow rest. The method may further include aiming the arrow with or without the use of the sight. Because various bows employ various parts and method and parts may differ between bows, one can envision various method for releasing the arrow from a PSA tape lined arrow rest or other friction sensitive surface.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

What is claimed is:

1) An improved crossbow, the crossbow comprising a rail lined, on the side that contacts the arrow, with a pressure sensitive tape, the tape having at least 5 mils in thickness, 5 oz/in peel adhesion, at least 5 lbs/in tensile strength, at least 100% elongation at break, and an operating temperature range of at least −20° F. to +350° F.

2) The improved crossbow of claim 1, wherein the pressure sensitive tape has at least 7 mils in thickness, 10 oz/in peel adhesion, at least 10 lbs/in tensile strength, at least 150% elongation at break, and an operating temperature range of at least −10° F. to +200° F.

3) The improved crossbow of claim 1, wherein the pressure sensitive tape has at least 9 mils in thickness, 15 oz/in peel adhesion, at least 15 lbs/in tensile strength, at least 200% elongation at break, and an operating temperature range of at least 0° F. to +150° F.,

4) The improved crossbow of claim 1, wherein the pressure sensitive tape has at least 9.5 mils in thickness, 20 oz/in peel adhesion, at least 20 lbs/in tensile strength, at least 200% elongation at break, and an operating temperature range of at least 10° F. to +25° F.

5) The improved crossbow of claim 1, wherein the pressure sensitive tape has at least 9.8 mils in thickness, 25 oz/in peel adhesion, at least 25 lbs/in tensile strength, at least 225% elongation at break, and an operating temperature range of at least 10° F. to +125° F.

6) The improved crossbow of claim 1, wherein the pressure sensitive tape is comprised of RULON®.

7) An improved bow, the bow comprising on a surface that contacts the arrow as it is released, a pressure sensitive tape, the tape having at least 5 mils in thickness, 5 oz/in peel adhesion, at least 5 lbs/in tensile strength, at least 100% elongation at break, and an operating temperature range of at least −20° F. to ±350° F.

8) The improved bow of claim 7, wherein the pressure sensitive tape has at least 7 mils in thickness, 10 oz/in peel adhesion, at least 10 lbs/in tensile strength, at least 150% elongation at break, and an operating temperature range of at least −10° F. to +200° F.

9) The improved bow of claim 7, wherein the pressure sensitive tape has at least 9 mils in thickness, 15 oz/in peel adhesion, at least 15 lbs/in tensile strength, at least 200% elongation at break, and an operating temperature range of at least 0° F. to +150° F.

10) The improved bow of claim 7, wherein the pressure sensitive tape has at least 9.5 mils in thickness, 20 oz/in peel adhesion, at least 20 lbs/in tensile strength, at least 200% elongation at break, and an operating temperature range of at least 10° F. to +125° F.

11) The improved bow of claim 7, wherein the pressure sensitive tape has at least 9.8 mils in thickness, 25 oz/in peel adhesion, at least 25 lbs/in tensile strength, at least 225% elongation at break, and an operating temperature range of at least 10° F. to +125° F.

12) The improved bow of claim 7, wherein the pressure sensitive tape is comprised of RULON®.

13) An improved method for shooting an arrow with a bow device, the method comprising:
a) lining a rail or arrow rest of the bow with a pressure sensitive tape, the tape being at least 5 mils in thickness, 5 oz/in peel adhesion, at least 5 lbs/in tensile strength, at least 100% elongation at break, and an operating temperature range of at least −20° F. to +350° F.;
b) fitting the arrow onto the serving;
c) drawing the arrow back; and
d) releasing the arrow.

14) The method of claim 13, wherein the pressure sensitive tape has at least 7 mils in thickness, 10 oz/in peel adhesion, at least 10 lbs/in tensile strength, at least 150% elongation at break, and an operating temperature range of at least −10° F. to +200° F.

15) The method of claim 13, wherein the pressure sensitive tape has at least 9 mils in thickness, 15 oz/in peel adhesion, at least 15 lbs/in tensile strength, at least 200% elongation at break, and an operating temperature range of at least 0° F. to +150° F.

16) The method of claim 13, wherein the pressure sensitive tape has at least 9.5 mils in thickness, 20 oz/in peel adhesion, at least 20 lbs/in tensile strength, at least 200% elongation at break, and an operating temperature range of at least 10° F. to +125° F.

17) The method of claim 13, wherein the pressure sensitive tape has at least 9.8 mils in thickness, 25 oz/in peel adhesion, at least 25 lbs/in tensile strength, at least 225% elongation at break, and an operating temperature range of at least 10° F. to +125° F.

18) The method of claim 13, wherein the pressure sensitive tape is RULON®.
